(19) United States
(12) Patent Application Publication
(10) Pub. No.: US 2020/0175617 A1
(43) Pub. Date: Jun. 4, 2020

(54) DISTRIBUTED AND DECENTRALIZED DERS SYSTEM OPTIMIZATIONS

(71) Applicant: Heila Technologies, Inc., Somerville, MA (US)

(72) Inventor: Jorge Elizondo Martinez, Somerville, MA (US)

(21) Appl. No.: 16/702,505

(22) Filed: Dec. 3, 2019

Related U.S. Application Data
(60) Provisional application No. 62/774,425, filed on Dec. 3, 2018.

(51) Int. Cl. G06Q 50/06; G06Q 30/02; G06Q 20/14; G06Q 40/04

(52) U.S. Cl. CPC G06Q 50/06; G06Q 40/04; G06Q 20/145; G06Q 30/0283

(57) ABSTRACT

A method optimizes an aggregated distributed energy resources system. The method receives a power objective for a DERs system that includes a plurality of assets. Each of the assets has an asset manager. A physical parameter related to the power objective is measured at a point of common coupling for the assets. The method selects one or more asset managers as an authority. The authority is configured to calculate a virtual price as a function of the measured physical parameter and the power objective. The virtual price is forwarded to one or more of the asset managers.

### PRIORITY

This patent application claims priority from provisional U.S. patent application No. 62/774,425, filed Dec. 3, 2018, entitled, “Decentralized Virtual Market Optimization,” and naming Jorge Elizondo Martinez as inventor, the disclosure of which is incorporated herein, in its entirety, by reference.

### FIELD OF THE INVENTION

Illustrative embodiments generally relate to power distribution networks and, more particularly, illustrative embodiments relate to making a power network more robust by removing the need for a dedicated central controller.

### BACKGROUND OF THE INVENTION

The electricity grid connects homes, businesses, and other buildings to central power sources. This interconnectedness requires centralized control and planning, where grid vulnerabilities can cascade quickly across the network. To mitigate these risks, aggregated distributed energy resources (“DERs”) systems (“DERs Systems”), such as microgrids are becoming a popular solution. Microgrids include controlled clusters of electricity generation and storage equipment, as well as loads that provide a coordinated response to a utility need and can also operate disconnected from the main grid. This increases the power system efficiency and reliability.

The US Department of Energy provides a formal definition of a microgrid as a group of interconnected assets, including loads and distributed energy resources, with clearly defined electrical boundaries that acts as a single controllable entity with respect to the grid. A microgrid often has distributed generators (e.g., diesel generators, gas turbines, etc.), batteries, as well as renewable resources like solar panels or wind turbines.

### SUMMARY OF VARIOUS EMBODIMENTS

In accordance with one embodiment of the invention, a method optimizes an aggregated distributed energy resources system. The method receives a power objective for a DERs system that includes a plurality of assets. Each of the assets has an asset manager. A physical parameter related to the power objective is measured at a point of common coupling for the assets. The method selects one or more asset managers as an authority. The authority is configured to calculate a virtual price as a function of the measured physical parameter and the power objective. The virtual price is forwarded to one or more of the asset managers.

The objective is set by an objective setter. The objective setter may be centralized agent and/or an asset manager. For example, the centralized agent may be a utility and/or an operator. However, in some embodiments, one or more objectives may be programmed in the asset managers (e.g., to remove the need for a single objective setter). In some embodiments, one or more independent devices located at one or more specific points of the DERs System may be used as a meter to measure the physical parameter related to the power objective. For example, an asset manager may be used as a meter. As another example, a voltage meter and/or a current meter may be used as the meter. The meter may measure at the point of common coupling. Additionally, or alternatively, the meter may measure at more than one point of common coupling. A plurality of measurements may be used to determine a measurement at a virtual point of common coupling. The meter may broadcast the measured values of the parameters to the one or more asset managers.

The method selects a first asset manager as the authority at a first time and selects a second asset manager as the authority at a second time. In some embodiments, the first asset manager and the second asset manager are selected at random. In some other embodiments, the first asset manager and the second asset manager are selected as the authority based on a pre-determined order. The authority forwards the price by broadcasting the price to the other asset managers

The price represents the energy transactions between different assets that maintain the DERs system substantially at an optimal operating point as defined by the cost function. Accordingly, the method may transact power and/or energy at each of the one or more of the asset managers on the basis of the virtual price. After the power and/or energy is transacted, a settlement step may be performed. The result of all the power and/or energy transactions are converted into economic exchange during the settlement step.

In some embodiments, each of the asset managers, from a plurality of the asset managers, calculates the price and broadcasts the calculated price to the other asset managers in the plurality of the asset managers. The system level price may be a function of the broadcast calculated preliminary prices. For example, the system level price may be a mean or a median of the broadcast calculated prices. In some embodiments, each of the asset managers 16 may calculate the system level price after receiving the preliminary prices from the other asset managers 16. Alternatively, one of the asset managers 16 may calculate the system level price after receiving the preliminary price from the other asset managers 16 and then broadcast the system level price.

In some embodiments, the authority calculates the virtual price and sends the virtual price to other asset managers. In return, the other asset managers reply to the authority with a bid. Each asset manager has a bid pair with each of a plurality of asset managers. The bid pair for each asset manager includes: (i) the bid of how much its own asset is willing to give to another asset, and (ii) what another asset is willing to give back. The bid pairs may be transformed into a list of peer-to-peer transactions, wherein the difference between the bids is the actual transaction.

In some embodiments, the method creates a public blockchain ledger. The ledger may be used to keep track of a list of power or energy transactions between the different assets of the system. A block may be created that includes a hash from a previous block, the list of power or energy transactions, a proof of work using a nonce, and a hash of all the elements above.

In accordance with another embodiment, a method of optimizing an aggregated distributed energy resources system sets the DERs system objective based on external and/or internal conditions. The method monitors the parameters that affect the DERs system objective. One or more asset managers receive the DERs system objective and the monitored parameter. The method determines, using the one or more asset managers, the energy transactions between different assets to maintain the system at an operation point in accordance with the system objective.

The method also transacts the determined energy transactions. The transactions may then be settled by calculating a dollar revenue that each asset has generated. The setting, monitoring, receiving, determining, and transacting steps may define a cycle. The method may repeat the cycle.

During the transactive step an asset manager may be selected to calculate the price. The asset manager calculates a price and broadcasts it to every other asset manager. All of the asset managers use the price to dispatch their respective asset. In some embodiments, the asset manager may calculate the price from a pre-compiled list so that the currently selected asset manager sends a “token” to the next one. In some other embodiments, the asset manager is randomly selected to calculate the price. Additionally, or alternatively, some or all asset managers may take turns to broadcast their own calculated price to every other asset manager in the system. The method then determines the optimization price as a function of all broadcasted prices.

During the transactive step, an asset manager may calculate and send a price to all other asset managers. The other asset managers reply with a bid, which is recorded. The process may be repeated with all the asset managers, so that by the end of the process every asset manager has a pair of bids to every other asset manager. Each bid pair for each asset manager includes: (i) the bid of how much its own asset is willing to give to another asset, and (ii) what another asset is willing to give back. The information may be transformed to a list of peer-to-peer transactions, with the difference between the bids being the actual transaction.

In some embodiments, the method creates a public blockchain ledger. The ledger may be used to track a series power or energy transactions between the different assets of the system. Every asset manager may calculate a price and bid pair and broadcast it to every other asset manager. After all price and bid pairs have been received, each asset manager may convert all price and bid pairs into a set of transactions to maximize its own performance in the system. Instead of dispatching immediately, each asset manager may broadcast its own calculated transaction. Blocks can be constructed to keep a secure record of all transactions.

In some embodiments, the result of all transactions is converted into actual economic exchange during a settlement step. The economic exchange of achieving the objective defined by the objective setter may be divided among agents in the system. The benefits of achieving the objective may be divided among the active assets in the system, and their benefit is related to the virtual currency profit they accumulated during the transactions. In some embodiments, the receiving, the measuring, the setting, and the forwarding define a cycle. In some embodiments, the method may repeat the cycle at a rate of between about 0.01 Hz and about 10 Hz.

In accordance with another embodiment, an asset manager is configured to control distribution of power within a DERs system. The DERs system has a plurality of assets. The asset manager is configured to operate with a given asset in the DERs system. The asset manager includes an interface configured to communicate with at least one (a) other asset manager, (b) meter, and/or (c) central controller, in the DERs system. The asset manager receives information relating to (a) a system-level objective, (b) meter information, and (c) an indication that the asset manager is selected as an authority. The asset manager includes a price calculation engine configured to calculate, when the asset manager receives an indication that the asset manager is selected as the authority, a price. The price is calculated as a function of the system-level objective and the meter information.

The interface is further configured to forward the price to one or more asset managers. In some embodiments, the asset manager requests the data independently. In some other embodiments, the asset manager receives the data passively.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A schematically shows a DERs system including asset managers that are used to optimize the operation of a plurality of assets to fulfill a system-wide objective in accordance with illustrative embodiments of the invention.

FIG. 1B schematically shows a virtual point of common coupling for two independent DERs systems and in accordance with illustrative embodiments of the invention.

FIG. 2 schematically shows an asset manager configured in accordance with illustrative embodiments of the invention.

FIGS. 3A-3C schematically shows examples of different approaches that can be used to optimize a DERs system in accordance with illustrative embodiments of the invention.

FIG. 4 schematically shows a process of optimizing the DERs system using distributed asset managers in accordance with illustrative embodiments of the invention.

FIG. 5 schematically shows an objective setter and a meter sending information to the one or more asset manager in accordance with illustrative embodiments of the invention.

FIG. 6 schematically shows a rotating scheme for determining the price in accordance with illustrative embodiments of the invention.

FIG. 7 schematically shows a price consensus scheme for determining a price in accordance with illustrative embodiments of the invention.

FIG. 8 schematically shows a transaction consensus scheme for determining the price in accordance with illustrative embodiments of the invention.

FIG. 9A schematically shows a block scheme of selecting an authority and determining the price in accordance with illustrative embodiments of the invention.

FIG. 9B schematically shows a blockchain ledger used in the optimization process in accordance with illustrative embodiments of the invention.

FIG. 10 shows a cyclical process of optimizing a DERs system using a decentralized approach in accordance with illustrative embodiments of the invention.

### DESCRIPTION OF ILLUSTRATIVE EMBODIMENTS

In illustrative embodiments, the control system for an aggregated distributed energy resources system (“DERs system”)—such as a microgrid, a group of microgrids, and/or a larger grid—calculates a price, which dictates whether assets in the system should increase power output or decrease power output. The price is calculated without the use of a dedicated central controller. Instead, illustrative embodiments use one or more of the distributed asset managers to calculate the price. Illustrative embodiments also provide a number of techniques for determining which of the one or more of the distributed asset managers calculates the price. In some embodiments, the asset manager that calculates the price changes from cycle to cycle. In some embodiments, a plurality of the asset managers calculate the price simultaneously. Details of illustrative embodiments are discussed below.

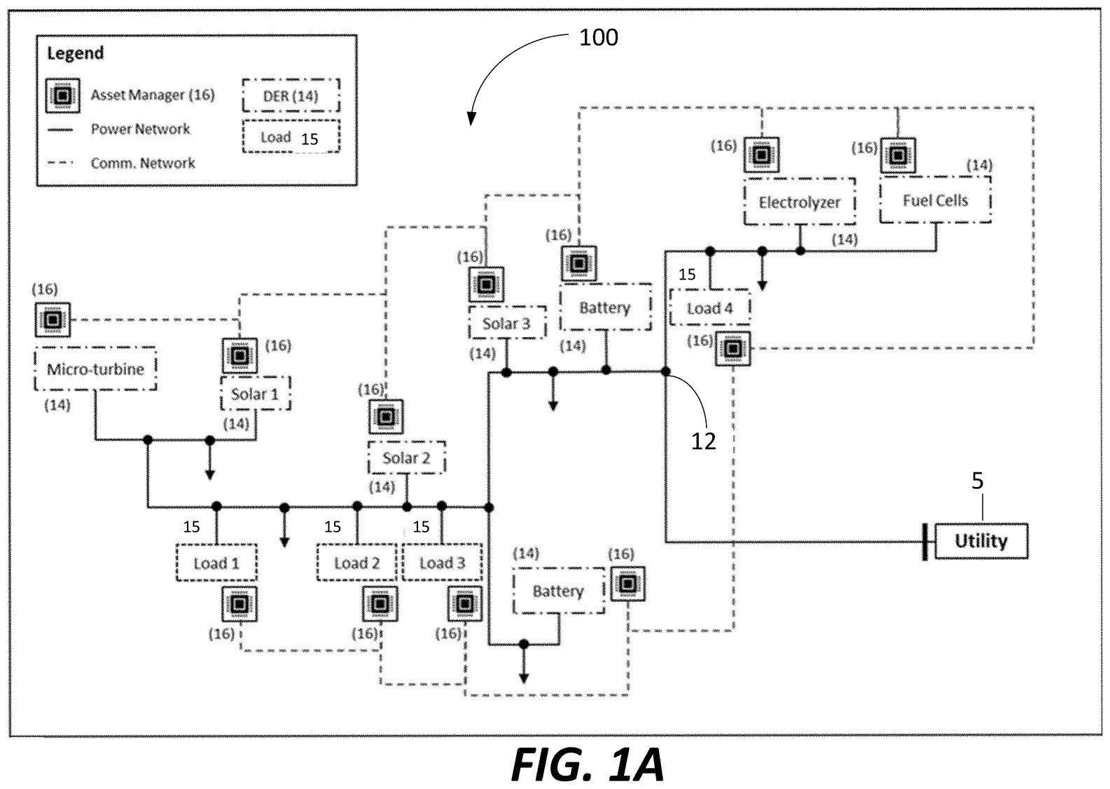

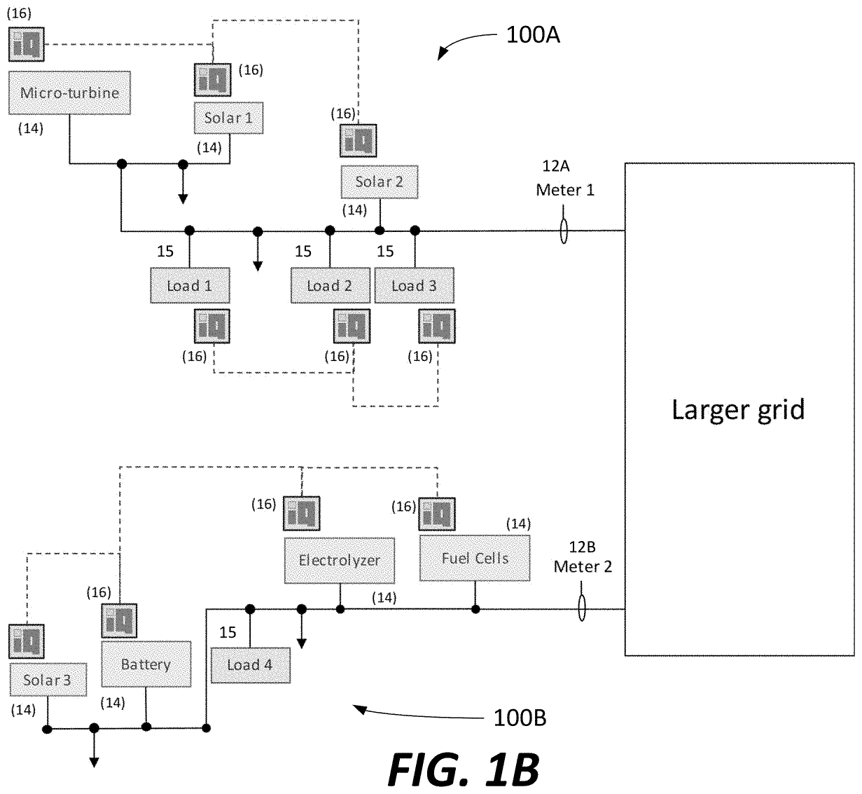

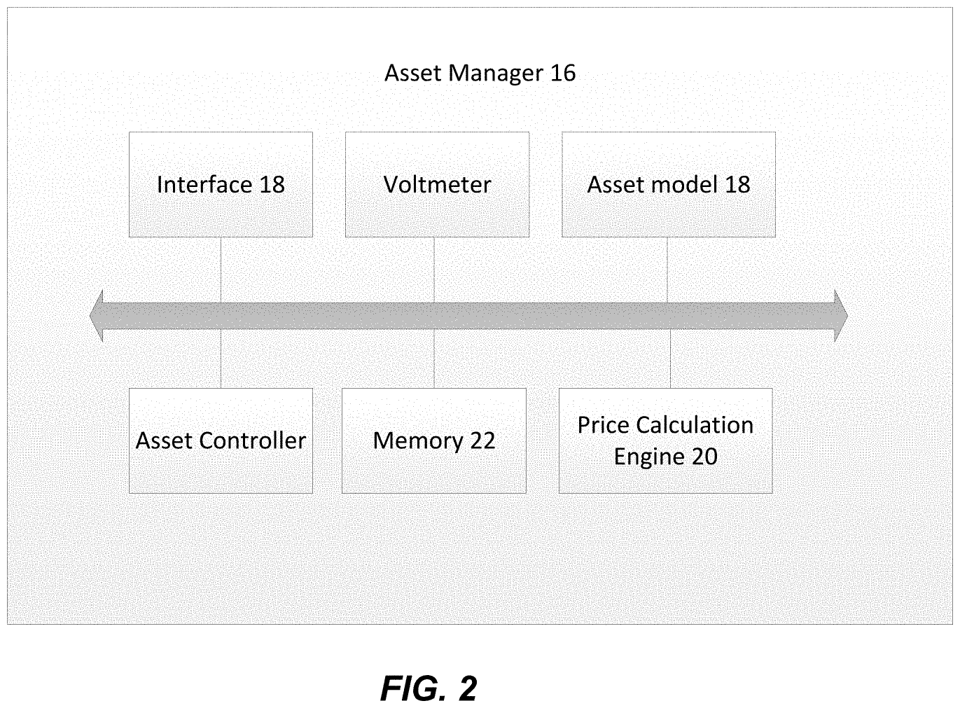

FIG. 1A schematically shows a DERs system 100 including asset managers 16 that are used to optimize the operation of a plurality of assets 14 to fulfill a system-wide objective in accordance with illustrative embodiments of the invention. Among other things, the asset 14 may be a DER or a load that exchanges real and reactive power with the power network. While both DERs and the loads 15 are traditionally considered to be assets, the loads 15 are discussed separately for purposes of this application. In some embodiments, at least one of the assets 14 is controllable by an asset manager 16 (described in additional detail with respect to FIG. 2). Additionally, a plurality of the assets 14 may be controlled by a single asset manager 16. However, in some embodiments, one or more assets 14 and/or loads 15 may not be coupled with the asset manager 16.

Like many DERs systems, the system 100 has a point of common coupling 12 through which power from the system 100 passes to an external network, such as a utility 5. While the term ‘point of common coupling 12’ is shown and described as a particular point, it should be understood that any point along the power network portion that leads from the utility 5 to the identified point is considered to be part of the point of common coupling 12 (e.g., any portion before the power network branches to the various assets 14). Furthermore, illustrative embodiments are intended to include a virtual point of common coupling (e.g., that is calculated from two or more points of common coupling 12).

FIG. 1B schematically shows a virtual point of common coupling for two independent DERs systems 100A and 100B in accordance with illustrative embodiments of the invention. The virtual point of common coupling is formed by combining meter information from the points of common coupling 12 of two or more independent aggregated DERs systems 100A and 100B (e.g., 12A and 12B). For example, the real power at the virtual point of common coupling is the sum of real power measured by meter 1 at the point of common coupling 12A and the real power measured by meter 2 at the point of common coupling 12B. Accordingly, any discussion relating to the point of common coupling 12 also applies to the virtual point of common coupling unless the context otherwise requires.

FIG. 2 schematically shows one of the asset managers 16 of FIG. 1A configured in accordance with illustrative embodiments of the invention. As shown, the asset manager 16 of FIG. 2 has a plurality of components that together perform some of its functions. Each of these components is operatively connected by any conventional interconnect mechanism. FIG. 2 simply shows a bus communicating with each of the components. Those skilled in the art should understand that this generalized representation can be modified to include other conventional direct or indirect connections. Accordingly, discussion of a bus is not intended to limit various embodiments.

Indeed, it should be noted that FIG. 2 only schematically shows each of these components. Those skilled in the art should understand that each of these components can be implemented in a variety of conventional manners, such as by using hardware, software, or a combination of hardware and software, across one or more other functional components. For example, the controller may be implemented using a plurality of microprocessors executing firmware. As another example, the controller may be implemented using one or more application specific integrated circuits (i.e., “ASICs”) and related software, or a combination of ASICs, discrete electronic components (e.g., transistors), and microprocessors. Accordingly, the representation of the controller and other components in a single box of FIG. 2 is for simplicity purposes only. In fact, in some embodiments, the controller of FIG. 2 is distributed across a plurality of different machines—not necessarily within the same housing or chassis.

The asset manager 16 includes a controller configured to, among other things, use local cost functions to manage operation of its asset(s) 14, and determine an operating point. For example, the operating point of the asset 14 may be the combination of the real and reactive power that the asset 14 is injecting into the system 100. The operating point may also include all the internal states of the asset 14, such as temperatures, stored energy, voltages, etc.

The asset manager 16 also includes an interface 18 to communicate with other assets 14 and/or other devices. For example, the interface 18 is configured to communicate with other asset managers 16 (e.g., to send and/or receive the price calculated by a price calculation engine 20 discussed below). Additionally, the interface 18 is configured to receive a system-wide objective. In illustrative embodiments, the system-wide objective may instruct the system 100 to provide a certain amount of real and/or reactive power to the utility 5 (e.g., the total output power of all of the assets 14 in the DERs system 100 should be 10 kWatts). Accordingly, compliance with the system-wide objective can be tracked by measuring the power at the point of common coupling 12.

The asset manager 16 also includes the price calculation engine 20, which calculates the price that is sent to the other asset managers 16. For clarity, in some embodiments of the invention, a “price” or “price signal” is a signal generated in a coordinated DERs system 100 that increases in value when there is more demand than supply of energy and decreases when there is more supply than demand. For example, the demand for power can come from the loads 15 and/or the utility 5. Additionally, the supply can come from the assets 14 and/or the utility 5. It can also be dependent on other variables, such as reactive power and system losses. In some embodiments, the price can be calculated using the following cost function:

pᵢ^{(k+1)}=gᵢ(pᵢ^{(k)},yₒᵤₜ,yₛₚ)

Where pᵢ^{(k)} is the price vector (or scalar) at time “k”, gᵢ is the price calculation function, yₒᵤₜ are the values of the output variables that are being tracked, and yₛₚ are the set-points for such variables.

Similarly, in some embodiments of the invention, a “response” is the determination of the real and reactive power outputs of the DER asset 14 obtained by minimizing a cost function of one or more of its variables with respect to power. In some illustrative embodiments, the cost function can take the form:

$${P}_{i}^{*} = {min}_{{P}_{i}} {J}_{i} ( {P}_{i} , {p}_{i} , {x}_{i} , Θ )$$

Where Pᵢ* is the calculated optimal output power vector, Jᵢ is the cost function, Pᵢ is the output power variable over which we optimize, pᵢ is the price signal described above, xᵢ is a vector of the asset or plurality of asset states and important variables, and Θ is a vector of external variables that affect performance.

Additional discussion of cost functions and the price can be found in U.S. patent application Ser. Nos. 16/054,377, and 16/683,148, which are both incorporated herein by reference in their entireties.

The asset manager 16 may also include a memory 22 for storing asset 14 data, a function generator configured to produce a local cost function, and an asset model used to emulate the behavior of any asset, such as diesel generators, gas turbines, batteries, solar panels, wind turbines, loads, etc. Although the interface 18 may communicate with the asset 14 using a protocol that may be proprietary to the respective asset 14, it preferably communicates with the central controller and/or other asset managers 16 and/or other agents inside and outside the DERs system 100 using a communication protocol commonly found in DERs systems 100. Each of these components and other components cooperate to perform the various discussed functions.

It should be reiterated that the representation of FIG. 2 is a significantly simplified representation of an actual asset manager 16. Those skilled in the art should understand that such a device may have many other physical and functional components, such as central processing units, communication modules, protocol translators, sensors, meters, etc. Accordingly, this discussion is in no way intended to suggest that FIG. 2 represents all the elements of an asset manager 16.

In addition to the components described herein, the asset manager 16 may include other modules, such as a voltmeter, topography engine, physical characteristic analysis engine, or others, as described in U.S. application Ser. Nos. 16/054,377, 16/054,967, and/or 16/683,148, all of which are incorporated herein by reference in their entireties.

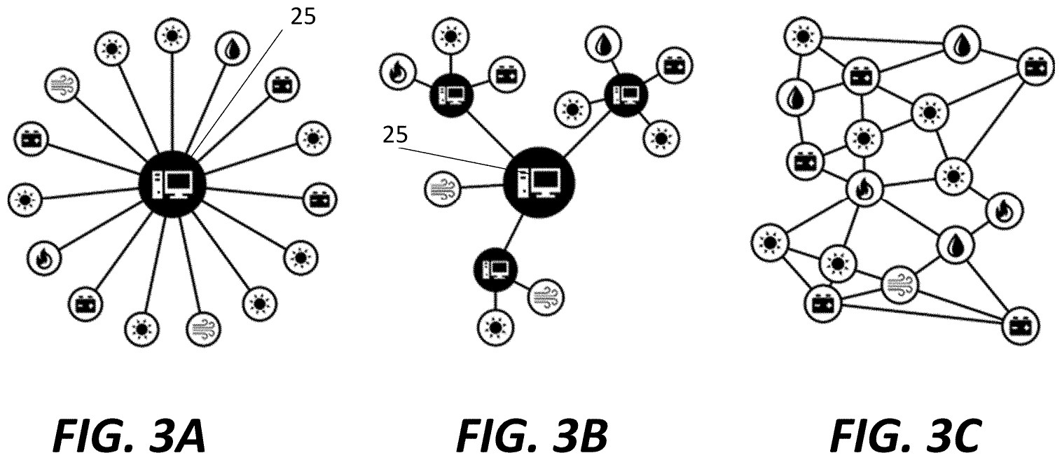

FIGS. 3A-3C schematically show three different schemes for optimization of the DERs system 100. In both FIGS. 3A and 3B a central controller 25 calculates the price and/or the set-point for the assets. FIG. 3A schematically shows a single centralized approach, where all the calculations, such as calculating set-points, are performed by the central controller 25. FIG. 3B schematically shows a distributed approach, where the optimization is achieved through the implementation of the dual-decomposition method or some other distributed optimization approach. For the DERs system 100, the distributed approach is more scalable, modular, secure, and reliable than the fully centralized one shown in FIG. 3A. However, the distributed approach of FIG. 3B relies on a central agent to act as a coordinator and perform some tasks such as calculating the dual variables, also known as prices. Thus, in a distributed system, one or more nodes distribute work to sub-nodes.

The inventor recognized that the dual-decomposition shown in FIG. 3B has a number of disadvantages, namely:
Requires a central agent 25.
It has a single point of failure, as it only works if the central agent 25 is functional. For example, if the central controller 25 is down, the optimization of the system 100 does not function. Additionally, if the central controller 25 becomes compromised, the price sent to every asset is compromised.
Requires that every asset trust the central agent 25. For example, if the DERs system 100 spans a neighborhood where every asset 14 is with a different homeowner, it is difficult to determine which home owner should be the authority.

FIG. 3C schematically shows the system 100 where the price is calculated by one or more of the assets 14 in accordance with illustrative embodiments of the invention. A dedicated central agent 25 is not required. Thus, in various embodiments of the innovation, the need for a dedicated central agent is removed. In some embodiments, the decentralized system has nodes (e.g., assets 14 and/or asset managers 16) that communicate directly with other peers (e.g., instead of through a node/sub-node distributed arrangement).

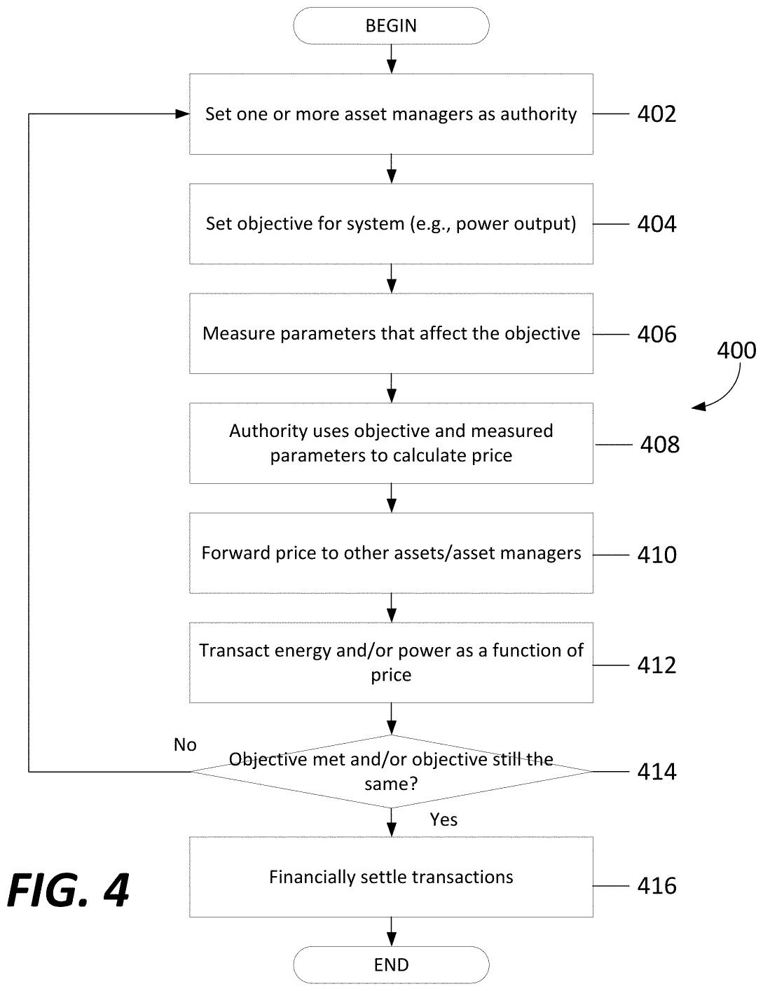

FIG. 4 schematically shows a process 400 of optimizing the DERs system 100 using distributed asset managers 16 in accordance with illustrative embodiments of the invention. It should be noted that this method is substantially simplified from a longer process that may normally be used. Accordingly, the method shown in FIG. 4 may have many other steps that those skilled in the art likely would use. In addition, some of the steps may be performed in a different order than that shown, or in parallel. Furthermore, some of these steps may be optional in some embodiments. Finally, although this process is discussed with regard to calculating and sending a single price signal, the process of FIG. 4 can be expanded to cover processes for calculating and sending a plurality of price signals in parallel or in succession. Accordingly, the process 400 is merely exemplary of one process in accordance with illustrative embodiments of the invention. Those skilled in the art therefore can modify the process as appropriate.

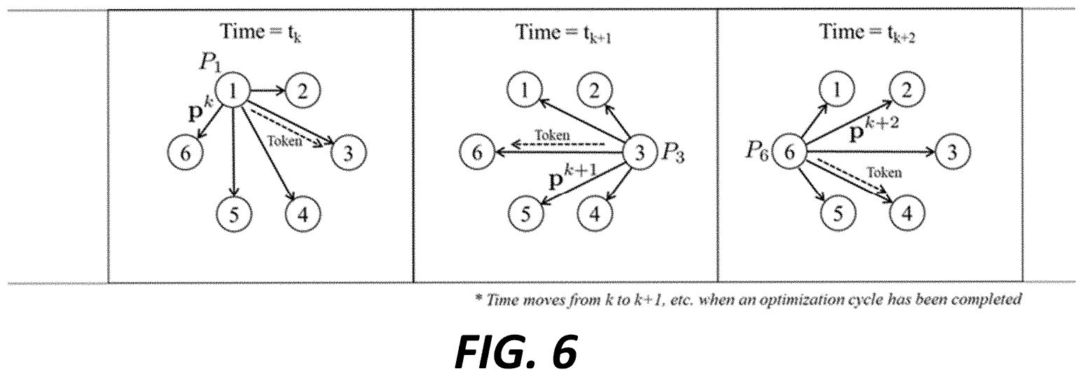

The process begins at step 402, which sets one or more asset managers 16 as an authority that calculates the price. As will be discussed in further detail below, the authority is the one or more asset manager(s) that calculate the price using a system-level cost function. In some embodiments, a plurality of asset managers 16 calculate respective prices (e.g., the preliminary price) that are used to determine the system level price. The authority also relays the price to the other asset managers 16 so as to control the output power of the assets 14 in the system 100. The one or more asset managers 16 that function as the authority are trusted by the other asset managers 16. In some embodiments, a first asset manager 16 is the authority at a first time. Then, a second asset manager 16 is the authority at a second time. In some other embodiments, a plurality of asset managers 16 may be the authority simultaneously. FIGS. 6-8A below schematically show various schemes of one or more asset managers 16 functioning as the authority to determine the system level price.

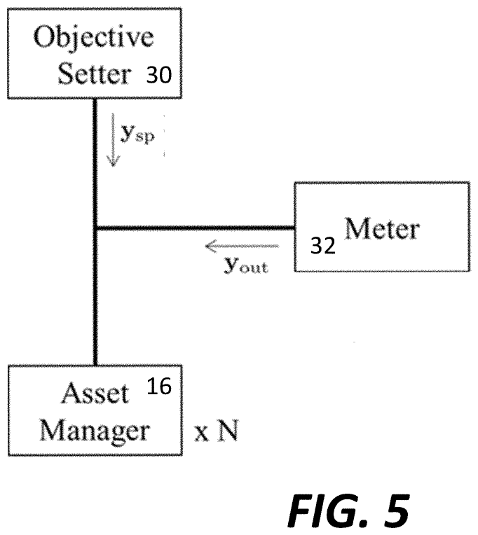

Returning to FIG. 4, the process 400 proceeds to step 404, which sets an objective for the DERs system 100. FIG. 5 schematically shows an objective setter 30 and a meter 32 sending information to the one or more asset manager 16 in accordance with illustrative embodiments of the invention. In some embodiments, the objective setter 30 is the entity that determines how the coordinated DERs system 100 behaves. For example, the objective setter 30 may set goals such as maintaining power flow at a certain level, frequency support, etc.

In some embodiments, the objective setter 30 is a centralized agent, such as a utility 5, a Supervisory Control and Data Acquisition (“SCADA”) system or a Building Management System (“BMS”), etc. Alternatively, the objective setter 30 can be one or more asset managers 16 (e.g., as a modulate in FIG. 2). In other embodiments, one or more objectives can be programmed in a plurality of the asset managers 16, thereby removing the need for a single objective setter 30 (e.g., where the system 100 maintains the point of common coupling 12 power flow at zero or some other pre-determined level).

As described previously, the objective may be a desired total power output from all of the assets 14 (including loads 15) in the system 100. In illustrative embodiments, an objective setter 30 determines the DERs system 100 objective. For example, the objective setter 30 may be a utility company, and/a person acting as an operator. In illustrative embodiments, the objective is set based on external and/or internal system 100 conditions. An external condition may be, for example, that a predefined amount of power needs to be supplied to the grid 14. An internal condition may be, for example, that a charge on a battery load in the system 100 is too low, and that the battery needs to be charged. The objective is received by one or more of the asset managers 16. In some embodiments, the asset managers 16 are configured to actively look for information relating to the objective. In some embodiments, the objective setter 30 may broadcast the objective to all of the asset managers 16. Alternatively, the variables may be forward to only a subset of the asset managers 16.

Among other things, the objective may define a predefined power output of the system 100 during a first time (e.g., during the day), and a different predefined power output of the system 100 during a second time (e.g., during the night). Additionally, or alternatively, the objective may be an immediate power output at the current time. In some embodiments, the power output of the system 100 may be measured at the point of common coupling 12, through which the power from all of the assets 14 in the system 100 passes.

At step 406, the process measures parameters that affect the objective. For example, the meter 32 of FIG. 5 monitors and/or measures the parameters that affect the objective. The meter 32 may be, for example, a voltage and/or a current meter. The meter 32 may be coupled with, and/or part of, one or more of the asset managers 16. The measured parameters are received by one or more of the asset managers. In some embodiments, the asset managers 16 are configured to actively look for information relating to the parameters measured by the meter 32. In some embodiments, the meter 32 may monitor and broadcast the variables (e.g., that are measured) that affect the objective to all of the asset managers 16. Alternatively, the variables may be forward to only a subset of the asset managers 16.

In some embodiments, the meter 32 monitors and tells the asset managers 16 what the current status of the system 100 is. This information may be used as a point of comparison to the system objectives. In illustrative embodiments, the meter 32 measures the power flow at the point of common coupling 12. In some other embodiments, one or more devices can be exclusively used as the meter 32, while in other embodiments, one or more asset managers 16 can be the meter 32. For example, when operating off-the-grid and the DER is the “master” or “grid-forming,” the asset manager 16 maybe the meter 32.

At step 408, one or more of the assets that are the authority use the information relating to the objective and the measured parameters to calculate the price. For example, the asset manager 16 may receive the relevant objective and meter information via the interface 18. That information may be stored in the memory 22. Additionally, as described previously, the price calculation engine 20 may calculate the price. At step 410, the authority forwards the price to the other asset managers 16. This may be done, for example, via the interface 18.

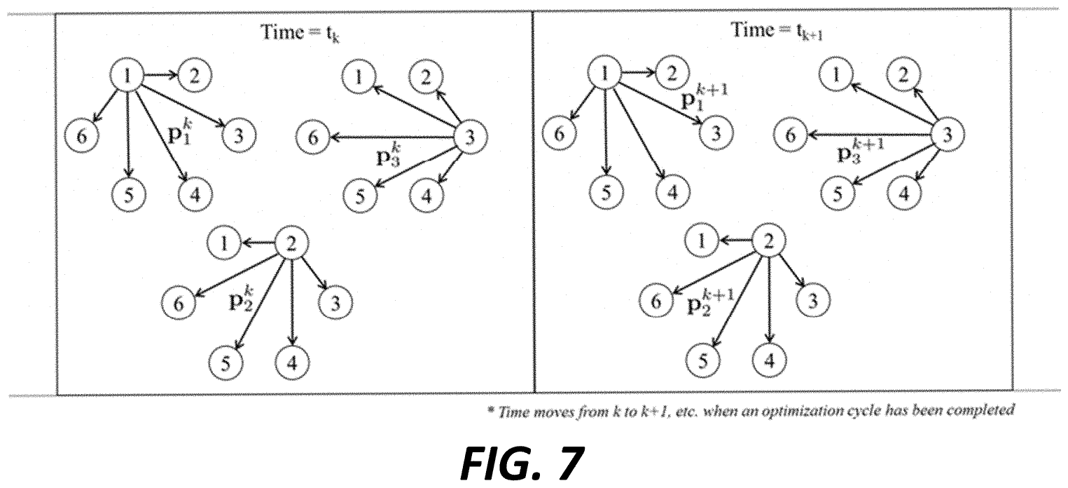

FIGS. 6-8A schematically show various schemes of one or more asset managers 16 calculating the price and forwarding the calculated price to other asset managers as in steps 408 and 410. FIG. 6 schematically shows a single asset manager 16 calculating the system level price, whereas FIGS. 7-9A show a plurality of asset managers calculating the preliminary price, which is used to calculate the system level price.

FIG. 6 schematically shows a rotating scheme for selecting an authority and determining the price in accordance with illustrative embodiments of the invention. As described previously, the authority is the one or more asset manager 16 that calculates the price, and/or a preliminary price used to calculate the system level price, and, in some embodiments, broadcasts it to every other asset manager 16. Each asset manager 16 then uses the price to dispatch their respective asset 14. In some embodiments, the asset manager 16 that calculates the price can be selected from a pre-compiled list so that the currently selected asset manager 16 sends a “token” to the next one (referred to as “token passing”); while in other embodiments, the authority asset manager 16 can select the next one at random and send it the token.

Although FIG. 6 only shows a single asset manager 16 as calculating and broadcasting the price, it should be understood that in some embodiments all of the asset managers 16 (e.g., asset manager 1, 2, 3, 4, 5, and 6) may calculate their respective price (e.g., the preliminary price) and send it to the other asset managers 16 at the same time (e.g., time=k). Additionally, or alternatively, all of the asset managers 16 (e.g., asset managers 1, 2, 3, 4, 5, and 6) may take turns calculating and broadcasting the system level price at different times.

FIG. 7 schematically shows a price consensus scheme for calculating the system level price in accordance with illustrative embodiments of the invention. In some embodiments, the system level price is set using a price consensus scheme. One or more of the asset managers 16 take turns calculating and broadcasting their own respective price (also referred to as the preliminary price) to every other asset manager 16 in the system 100. In some embodiments, all of the asset managers 16 calculate and broadcast their respective price. However, in some embodiments, not all of the asset managers 16 calculate and broadcast their respective price. All preliminary prices are accumulated, and the system level price used for optimization is a function of all the broadcasted preliminary prices:

p^{k}=ƒ(p₁^{k},p₂^{k}, . . . , p_{N}^{k})

In some illustrative embodiments, this function can be the median or the mean of the preliminary prices. The order in which the preliminary prices are broadcasted can follow some of the embodiments of the previously described technique (e.g., the rotating authority). Furthermore, although FIG. 7 only shows asset managers 1, 2, and 3 as calculating and sending the preliminary price, in some embodiments, all of the asset managers 16 (e.g., asset managers 1, 2, 3, 4, 5, and 6) may calculate and send (e.g., broadcast) their preliminary price.

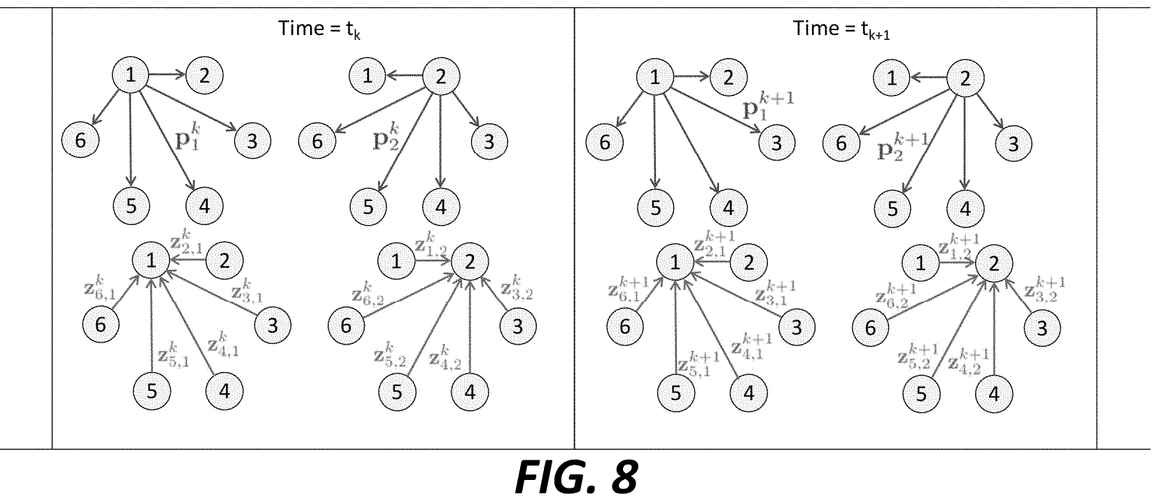

FIG. 8 schematically shows a transaction consensus scheme for calculating the system level price in accordance with illustrative embodiments of the invention. Each of the asset managers 16 that is selected as the authority calculates and sends the preliminary price (e.g., p₁^{k}) to all other asset managers 16 that reply with a bid (e.g., z_{2,1}^{k}) that gets recorded. The process may be repeated by all of the asset managers 16, so that by the end every asset manager 16 has a pair of bids with every other asset manager 16, where one bid (i) represents how much real and/or reactive power its own asset 14 is willing to give to another asset 14, and another one (ii) represents how much real and/or reactive power another asset 14 will give back as a result of the optimization (e.g., where each asset manager 16 determines the output using the cost function). This information can be compiled into a list of peer-to-peer transactions, with the difference between the bids being the actual transaction, ensuring the consensus of every asset manager 16.

As shown in FIG. 8, at time k, asset managers 1 and 2 send their respective calculated price to the other asset managers 2, 3, 4, 5, and 6, and 1, 3, 4, 5, and 6, respectively. Each of the asset managers that receives the price then responds with a bid (e.g., asset managers 2, 3, 4, 5, and 6 send the bid to asset manager 1; and asset managers 1, 3, 4, 5, and 6 send the bid to asset manager 2). In some embodiments, after the optimization cycle has been completed (e.g., at a later time, k+1) the cycle may be repeated. Although FIG. 7 only shows asset managers 1 and 2 as calculating and send the price, in some embodiments, all of the asset managers 16 (e.g., asset manager 1, 2, 3, 4, 5, and 6) calculate their respective price and send it to the other asset managers 16, which respond with a bid.

In some embodiments, after repeating the process for all the assets 14 at a time step “tₖ” in the system (or at least the ones that are desired to transact among each other) each pair of assets “i” and “j” will be associated to a pair of “bids”:
Amount of power that asset “i” wants to send to asset “j” as a reaction of asset “j” price: z_{i,j}^{k}
Amount of power that asset “j” wants to send to asset “i” as a reaction of asset “i” price: z_{j,i}^{k}

This pair of “bids” can be regarded as a peer-to-peer transaction between these two assets 14, with the difference between the bids being the actual transaction. For example, if asset 1 wants to give asset 2 a total of 20 kW, and asset 2 wants to give asset 1 a total of 5 kW, the actual transaction is 15 kW from asset 1 to asset 2.

According to one illustrative embodiment, the totality of all peer-to-peer transactions for all assets gives the dispatch for asset “i” at time “tₖ”:

$${z}_{i}^{k} = {\sum }_{j} {z}_{i , j}^{k}$$

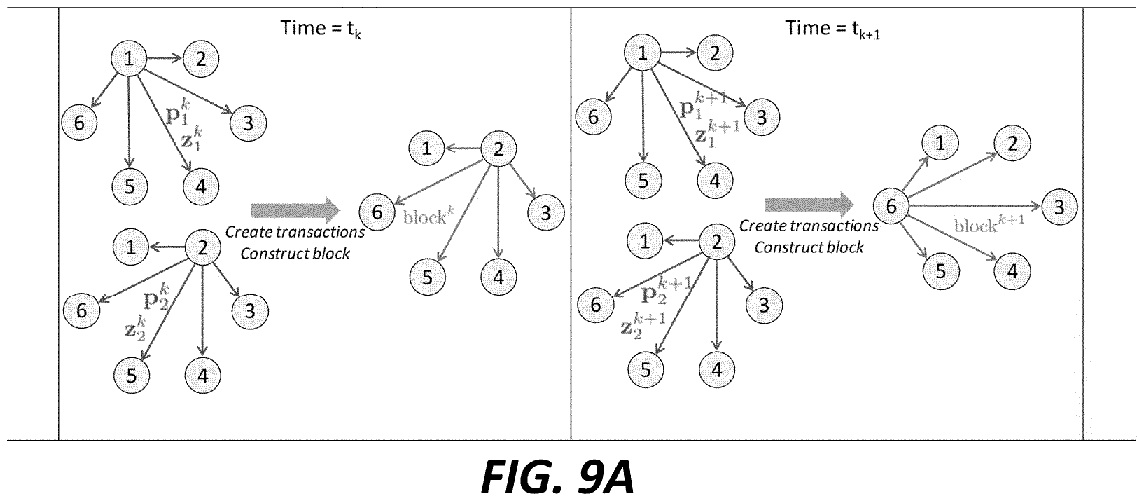

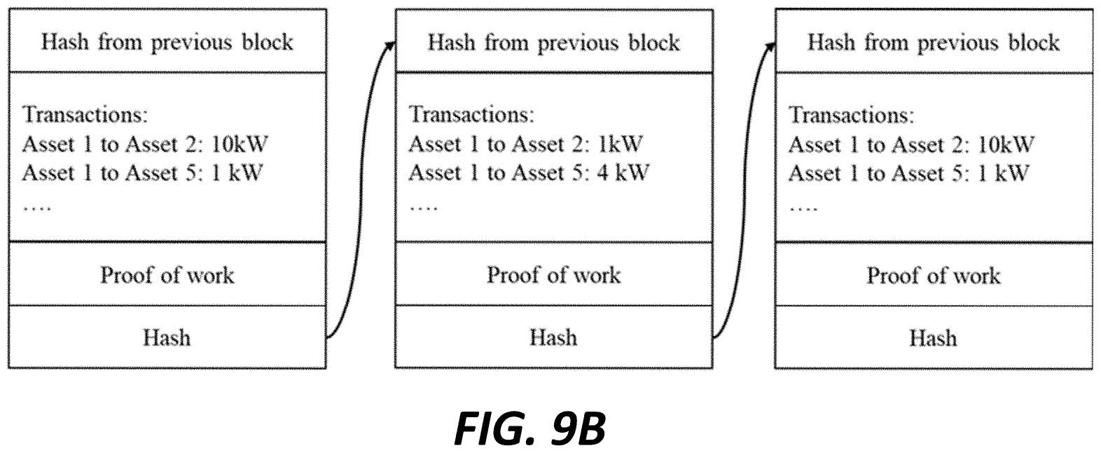

FIG. 9A schematically shows a blockchain ledger scheme for keeping track of a series of power or energy transactions between the different agents in the system 100 in a secure manner. In some embodiments, every asset manager 16 calculates a price and bid pair and broadcasts it to every other asset manager 16. When all the pairs have been received, every asset 14 converts all price and bid pairs into a set of transactions that optimizes its own performance in the system 100. In some embodiments, instead of dispatching immediately, every asset manager 16 can first broadcast its own calculated transaction so that blocks can be constructed to keep a secure record of all transactions.

Although FIG. 9A only shows asset managers 1 and 2 as calculating and sending the price, it should be understood that in some embodiments all of the asset managers 16 (e.g., asset manager 1, 2, 3, 4, 5, and 6) calculate their respective price and send it to the other asset managers 16.

FIG. 9B schematically shows a blockchain ledger used in the optimization process in accordance with illustrative embodiments of the invention. A block is created that includes the hash from the previous block, the list of transactions, a “proof of work” (using a “nonce”), and finally a hash of all the elements above to link all the blocks together to obtain a safe structure.

At step 412, the process transacts energy and/or power as a function of price. The asset managers 16 determine the necessary energy transactions needed between different assets based on the received price, such that the system may be said to be maintained substantially at an optimal operation point.

At step 414, the process asks if the objective has not been met, or if the objective has changed. If the answer to either of these is yes (e.g., the objective is not met, or the objective changed), then the cycle is repeated and returns to step 402. Otherwise, the process proceeds to step 416.

The process then proceeds to step 416, where the transactions are financially settled. During the settlement step, the result of all of the transactions are converted into actual economic exchange. In various embodiments the economic impact of achieving the objective defined by the objective setter 30 is distributed among the members of the system 100. The system 100 keeps track of all of the energy exchanges. For every price signal, each asset 14 reacts and gives some amount of power. When the price calculated by the authority is high, and the system 100 needs energy, the amount of energy each asset 14 gave for a given price signal can be tracked. For example, if the system 100 is in a neighborhood, and the entire system 100 earns $100, the value that each asset is entitled to may be calculated as a function of the power provided and the price at the time the power is provided. Accordingly, illustrative embodiments track transactions and the prices to provide a fair way to compensate the various asset 14 owners.

As described by the following illustrative examples:
Reducing the energy consumption of a building reduces the amount of money to pay the utility 5. Savings can be distributed among the different assets.
Exporting energy to the utility 5 provides new income. Revenue or profits can be distributed.
Reducing diesel consumption in an island grid leads to monetary savings. Savings can be distributed.

Furthermore, in some embodiments, the benefits of achieving the objective are divided among the active assets 14 in the system 100, and their benefit is related to the “virtual currency profit” the asset 14 accumulates during the transactions. In illustrative embodiments, the “virtual currency profit” can be calculated by every asset 14 as either an integral or a sum

$$R = {{\int }^{{t}_{N}}}_{0} p \cdot {P}^{*} dt$$

$$R = {{\sum }^{{t}_{N}}}_{0} p \cdot {P}^{*}$$

Where p is the virtual price calculated in each transaction, and P* the optimized output.

In some embodiments, during the settlement step 416 of the optimization, all transactions can be converted into actual economic exchange. In some embodiments, the frequency in which the settlement step 416 is done is independent from the transaction cycle, but they can be the same in some cases. The process 400 then comes to an end.

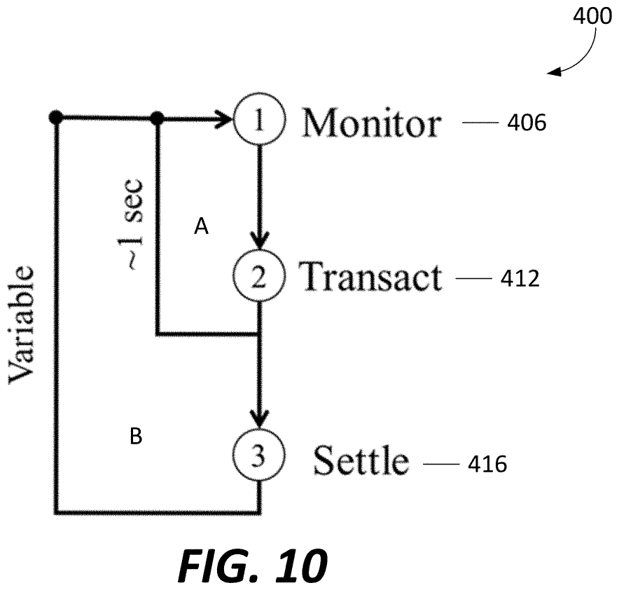

While step 404 is shown as coming after step 402, it should be understood, that in some embodiments, that step 404 may come before step 402. Additionally, when the process 400 is repeated, step 404 may be happening before or after step 402. In a similar manner, step 406 may also come before step 402. FIG. 10 schematically shows that in some embodiments, step 406 and step 412 may run on a different loop from step 416. Thus, in some embodiments, some of the steps may be repeated a plurality of times before the process 400 is fully completed from beginning to end.

FIG. 10 schematically shows an alternative embodiment of part of the process 400 with two loops running simultaneously. Although the process 400 shows the steps 402-416 running sequentially, in some embodiments, a second process 400 may begin while the first process 400 is still running. For example, the process 400 can include two loops, A and B. The inner loop A may run on a short time scale (typically every second or less), to help maintain the system 100 at or near the optimal operation point. The outer loop B, which settles the transactions by determining the economic transactions netted by each asset 14, may run at a variable rate.

A person of skill in the art understands that illustrative embodiments provide a number of advantages. For example, advantages include that no dedicated central controller is required to calculate the price. Furthermore, the system 100 is more robust because it does not have a single point of failure. Additionally, if one asset manager 16 is compromised, the other asset managers 16 may substantially correct the price (e.g., during the rotational authority scheme, or by averaging the prices).

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Disclosed embodiments, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A method of optimizing an aggregated distributed energy resources system (“DERs system”), the method comprising:
receiving a power objective for a DERs system including a plurality of assets, each of the assets having an asset manager;
measuring a physical parameter related to the power objective at a point of common coupling for the assets;
setting one or more asset managers as an authority, wherein the authority is configured to calculate a virtual price as a function of the measured physical parameter and the power objective; and
forwarding the virtual price to one or more of the asset managers.

2. The method as defined by claim 1, further comprising setting a first asset manager as the authority at a first time, and setting a second asset manager as the authority at a second time.

3. The method as defined by claim 2, wherein the first asset manager and the second asset manager are selected randomly.

4. The method as defined by claim 2, wherein the first asset manager and the second asset manager are selected as the authority based on a pre-determined order.

5. The method as defined by claim 1, wherein the authority forwards the price by broadcasting the price to the other asset managers.

6. The method as defined by claim 1, further comprising:
wherein the price represents the energy transactions between different assets that maintain the DERs system substantially at an optimal operating point as defined by the cost function.

7. The method as defined by claim 1, further comprising:
transacting power and/or energy at each of the one or more of the asset managers on the basis of the virtual price.

8. The method as defined by claim 7, further comprising:
performing a settlement step, where the result of all the power and/or energy transactions are converted into economic exchange.

9. The method as defined by claim 1, wherein each of the asset managers, from a plurality of the asset managers, calculates the price and broadcasts the calculated price to the other asset managers in the plurality of the asset managers.

10. The method as defined by claim 9, wherein the system level price is a function of the broadcast preliminary prices.

11. The method as defined by claim 1, further comprising:
the authority calculating the virtual price;
sending the virtual price to other asset managers; and
the other asset managers replying to the authority with a bid.

12. The method as defined by claim 11,
wherein each asset manager has a bid pair with each of a plurality of asset managers, wherein the pair includes: (i) the bid of how much its own asset is willing to give to another asset, and (ii) what another asset is willing to give back,
the method further comprising transforming bid pairs to a list of peer-to-peer transactions, wherein the difference between the bids is the actual transaction.

13. The method as defined by claim 1, further comprising:
creating a public blockchain ledger;
using the ledger to keep track of a list of power or energy transactions between the different assets of the system.

14. The method as defined by claim 1, wherein the point of common coupling is a virtual point of common coupling.

15. A method of optimizing an aggregated distributed energy resources system (“DERs System” as noted above), the method comprising:
setting the DERs system objective based on external and/or internal conditions,
monitoring parameters that affect the DERs system objective;
receiving, at one or more asset managers, the DERs system objective and the monitored parameter; and
determining, using the one or more asset managers, the energy transactions between different assets to maintain the system at an operation point in accordance with the system objective.

16. The method as defined by claim 15, further comprising transacting the determined energy transactions.

17. The method as defined by claim 16, further comprising settling the transactions by calculating a dollar revenue that each asset has generated.

18. The method as defined by claim 17, wherein the setting, monitoring, receiving, determining, and transacting steps define a cycle, the method further comprising repeating the cycle.

19. The method as defined by claim 15, wherein the objective is set by an “objective setter” and the parameters are monitor by a meter that broadcast the parameters to the one or more asset managers.

20. An asset manager configured to control distribution of power within a distributed energy resources system (“DERs system”), the DERs system having a plurality of assets, the asset manager being configured to operate with a given asset in the DERs system, the asset manager comprising:
an interface configured to:
communicate with at least one (a) other asset manager, (b) meter, and/or (c) central controller, in the DERs system, and
receive information relating to (a) a system-level objective, (b) meter information, and (c) an indication that the asset manager is selected as an authority;
a price calculation engine configured to calculate, when the asset manager receives an indication that the asset manager is selected as the authority, a price as a function of the system-level objective and the meter information; and
the interface further configured to forward the price to one or more asset managers.
